(19) United States
(12) Patent Application Publication
(10) Pub. No.: US 2026/0078531 A1
(43) Pub. Date: Mar. 19, 2026

(54) Method of Making a Thermoplastic Copolyester Elastomer-Based Fiber

(71) Applicant: Celanese Polymers Holding, Inc., Wilmington, DE (US)

(72) Inventors: Carmen A. Covelli, Chadds Ford, PA (US); Jamie Gaitor, Villanova, PA (US); Edward Maxwell de Brant Smith, Wilmington, DE (US)

(21) Appl. No.: 19/329,733

(22) Filed: Sep. 16, 2025

Related U.S. Application Data
(60) Provisional application No. 63/696,403, filed on Sep. 19, 2024.

(51) Int. Cl. D01F 6/84; C08G 63/88; D01D 5/08; D04B 1/16

(52) U.S. Cl. CPC D01F 6/84; C08G 63/88; D01D 5/08; D04B 1/16; D10B 2331/04; D10B 2401/06

(57) ABSTRACT

A method of making a thermoplastic copolyester elastomer-based fiber is disclosed. The method comprises: providing a thermoplastic copolyester elastomer having a number average molecular weight of greater than 35,000 g/mol; and spinning the thermoplastic copolyester elastomer to provide a fiber comprising a spun thermoplastic copolyester elastomer, wherein the spun thermoplastic copolyester elastomer has a number average molecular weight that is 98% or less to 50% or more the number average molecular weight of the thermoplastic copolyester elastomer. A thermoplastic copolyester elastomer-based fiber made according to the aforementioned method and a fabric comprising the aforementioned thermoplastic copolyester elastomer-based fiber are also disclosed.

### RELATED APPLICATIONS

The present application is based upon and claims priority to U.S. Provisional Patent Application Ser. No. 63/696,403 having a filing date of Sep. 19, 2024, which is incorporated herein by reference.

### BACKGROUND

Engineering thermoplastics are often used in numerous and diverse applications. For instance, polyesters and thermoplastic copolyester elastomers are used to produce all different types of articles, including apparel and garments, due to their properties and processing capabilities. Depending on the particular application, even for particular articles such as apparel and garments, it may be desired to have a fiber including certain properties to provide a resulting fabric and article with certain properties. Furthermore, such fibers may be made utilizing various processes, which may affect the ultimate properties of the fiber. In particular, depending on the processing conditions, the polyester or thermoplastic copolyester elastomer utilized in making such fiber may undergo degradation, and it may be desired to minimize any such degradation to maintain the properties of the polyester or thermoplastic copolyester elastomer.

As such, a need currently exists for providing an improved method of forming a thermoplastic copolyester elastomer-based fiber.

### SUMMARY OF THE DISCLOSURE

In accordance with one embodiment of the present disclosure, a method of making a thermoplastic copolyester elastomer-based fiber is disclosed. The method comprises: providing a thermoplastic copolyester elastomer having a number average molecular weight of greater than 35,000 g/mol; and spinning the thermoplastic copolyester elastomer to provide a fiber comprising a spun thermoplastic copolyester elastomer, wherein the spun thermoplastic copolyester elastomer has a number average molecular weight that is 98% or less to 50% or more the number average molecular weight of the thermoplastic copolyester elastomer.

In accordance with another embodiment of the present disclosure, a thermoplastic copolyester elastomer-based fiber is disclosed. The thermoplastic copolyester elastomer-based fiber is made according to the aforementioned method. In this regard, the method comprises: providing a thermoplastic copolyester elastomer having a number average molecular weight of greater than 35,000 g/mol; and spinning the thermoplastic copolyester elastomer to provide a fiber comprising a spun thermoplastic copolyester elastomer, wherein the spun thermoplastic copolyester elastomer has a number average molecular weight that is 98% or less to 50% or more the number average molecular weight of the thermoplastic copolyester elastomer.

In accordance with another embodiment of the present disclosure, a fabric is disclosed. The fabric comprises the aforementioned thermoplastic copolyester elastomer-based fiber made according to the aforementioned method. In this regard, the method comprises: providing a thermoplastic copolyester elastomer having a number average molecular weight of greater than 35,000 g/mol; and spinning the thermoplastic copolyester elastomer to provide a fiber comprising a spun thermoplastic copolyester elastomer, wherein the spun thermoplastic copolyester elastomer has a number average molecular weight that is 98% or less to 50% or more the number average molecular weight of the thermoplastic copolyester elastomer.

Other features and aspects of the present disclosure are set forth in greater detail below.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a method of making a thermoplastic copolyester elastomer-based fiber. The method allows for control of the molecular weight of the thermoplastic copolyester elastomer utilized in making such fiber. By controlling the molecular weight of the thermoplastic copolyester elastomer, certain properties may be retained. In this regard, the present inventors have discovered that by providing such a fiber and utilizing a method as disclosed herein, particular fiber properties may be realized. As a result, the fiber may be utilized for spinning to make yarns and articles. In turn, the resulting article having the desired properties and characteristics can be obtained.

As indicated herein, one of the properties controlled during processing of the thermoplastic copolyester elastomer is the molecular weight, particularly the number average molecular weight. In this regard, the initial thermoplastic copolyester elastomer may have a number average molecular weight of greater than 35,000 g/mol prior to the processing. For instance, the number average molecular weight may be more than 35,000 g/mol, such as 36,000 g/mol or more, such as 37,000 g/mol or more, such as 38,000 g/mol or more, such as 39,000 g/mol or more, such as 40,000 g/mol or more, such as 42,000 g/mol or more, such as 44,000 g/mol or more, such as 46,000 g/mol or more, such as 48,000 g/mol or more, such as 50,000 g/mol or more, such as 52,000 g/mol or more, such as 56,000 g/mol or more, such as 60,000 g/mol or more, such as 64,000 g/mol or more, such as 68,000 g/mol or more, such as 72,000 g/mol or more, such as 76,000 g/mol or more, such as 80,000 g/mol or more, such as 84,000 g/mol or more, such as 88,000 g/mol or more, such as 92,000 g/mol or more, such as 96,000 g/mol or more. The number average molecular weight may be 100,000 g/mol or less, such as 98,000 g/mol or less, such as 94,000 g/mol or less, such as 90,000 g/mol or less, such as 86,000 g/mol or less, such as 82,000 g/mol or less, such as 78,000 g/mol or less, such as 74,000 g/mol or less, such as 70,000 g/mol or less, such as 66,000 g/mol or less, such as 62,000 g/mol or less, such as 58,000 g/mol or less, such as 58,000 g/mol or less, such as 56,000 g/mol or less, such as 54,000 g/mol or less, such as 52,000 g/mol or less, such as 50,000 g/mol or less, such as 48,000 g/mol or less, such as 46,000 g/mol or less, such as 44,000 g/mol or less, such as 42,000 g/mol or less, such as 40,000 g/mol or less, such as 38,000 g/mol or less, such as 36,000 g/mol or less. The number average molecular weight may be determined using means generally known in the art, such as gel permeation chromatography.

The polydispersity index of the initial thermoplastic copolyester elastomer may be 1 or more, such as 1.1 or more, such as 1.2 or more, such as 1.3 or more, such as 1.4 or more, such as 1.5 or more, such as 1.6 or more, such as 1.7 or more, such as 1.8 or more, such as 1.9 or more, such as 2 or more. The polydispersity index may be 2.5 or less, such as 2.4 or less, such as 2.3 or less, such as 2.2 or less, such as 2.1 or less, such as 2 or less, such as 1.9 or less, such as 1.8 or less, such as 1.7 or less.

As indicated herein, the number average molecular weight may be reduced due to the processing. In this regard, the number average molecular weight of the final thermoplastic copolyester elastomer (or spun thermoplastic copolyester elastomer or processed thermoplastic copolyester elastomer) may be 98% or less, such as 97% or less, such as 95% or less, such as 93% or less, such as 90% or less, such as 87% or less, such as 85% or less, such as 83% or less, such as 80% or less, such as 77% or less, such as 75% or less, such as 73% or less of the number average molecular weight of the initial thermoplastic copolyester elastomer. The number average molecular weight of the final thermoplastic copolyester elastomer (or spun thermoplastic copolyester elastomer or processed thermoplastic copolyester elastomer) may be 50% or more, such as 53% or more, such as 55% or more, such as 57% or more, such as 60% or more, such as 63% or more, such as 65% or more, such as 67% or more, such as 70% or more, such as 73% or more, such as 75% or more, such as 77% or more, such as 80% or more, such as 83% or more, such as 85% or more, such as 87% or more, such as 90% or more, such as 93% or more, such as 95% or more of the number average molecular weight of the initial thermoplastic copolyester elastomer.

In other words, the number average molecular weight of the initial thermoplastic copolyester elastomer may be reduced, due to the processing, by 5% or more, such as 7% or more, such as 10% or more, such as 15% or more, such as 20% or more, such as 25% or more, such as 30% or more, such as 35% or more. The number average molecular weight of the initial thermoplastic copolyester elastomer may be reduced 50% or less, such as 45% or less, such as 40% or less, such as 35% or less, such as 30% or less, such as 25% or less, such as 20% or less, such as 17% or less, such as 15% or less, such as 13% or less, such as 10% or less, such as 8% or less.

Accordingly, the final thermoplastic copolyester elastomer (or spun thermoplastic copolyester elastomer or processed thermoplastic copolyester elastomer) may have a number average molecular weight of 20,000 g/mol or more, such as 22,000 g/mol or more, such as 24,000 g/mol or more, such as 26,000 g/mol or more, such as 28,000 g/mol or more, such as 30,000 g/mol or more, such as 32,000 g/mol or more, such as 34,000 g/mol or more, such as 36,000 g/mol or more, such as 38,000 g/mol or more, such as 40,000 g/mol or more, such as 42,000 g/mol or more, such as 44,000 g/mol or more, such as 46,000 g/mol or more, such as 48,000 g/mol or more, such as 50,000 g/mol or more. The final thermoplastic copolyester elastomer (or spun thermoplastic copolyester elastomer or processed thermoplastic copolyester elastomer) may have a number average molecular weight of 70,000 g/mol or less, such as 66,000 g/mol or less, such as 62,000 g/mol or less, such as 58,000 g/mol or less, such as 54,000 g/mol or less, such as 52,000 g/mol or less, such as 50,000 g/mol or less, such as 48,000 g/mol or less, such as 46,000 g/mol or less, such as 44,000 g/mol or less, such as 42,000 g/mol or less, such as 40,000 g/mol or less, such as 38,000 g/mol or less, such as 36,000 g/mol or less, such as 35,000 g/mol or less, such as 34,000 g/mol or less, such as 32,000 g/mol or less, such as 30,000 g/mol or less. Regardless, such number average molecular weight of the final thermoplastic copolyester elastomer (or spun thermoplastic copolyester elastomer or processed thermoplastic copolyester elastomer) is less than the number average molecular weight of the initial thermoplastic copolyester elastomer. Further, the number average molecular weight may be determined using means generally known in the art, such as gel permeation chromatography.

The polydispersity index of the final thermoplastic copolyester elastomer may be 1 or more, such as 1.1 or more, such as 1.2 or more, such as 1.3 or more, such as 1.4 or more, such as 1.5 or more, such as 1.6 or more, such as 1.7 or more, such as 1.8 or more, such as 1.9 or more, such as 2 or more. The polydispersity index may be 2.5 or less, such as 2.4 or less, such as 2.3 or less, such as 2.2 or less, such as 2.1 or less, such as 2 or less, such as 1.9 or less, such as 1.8 or less, such as 1.7 or less.

In addition to the number average molecular weight as defined above, the initial thermoplastic copolyester elastomer may have a weight average molecular weight of greater than 50,000 g/mol prior to the processing. For instance, the weight average molecular weight may be more than 50,000 g/mol, such as 52,000 g/mol or more, such as 54,000 g/mol or more, such as 56,000 g/mol or more, such as 58,000 g/mol or more, such as 60,000 g/mol or more, such as 62,000 g/mol or more, such as 64,000 g/mol or more, such as 66,000 g/mol or more, such as 68,000 g/mol or more, such as 70,000 g/mol or more, such as 74,000 g/mol or more, such as 78,000 g/mol or more, such as 82,000 g/mol or more, such as 86,000 g/mol or more, such as 90,000 g/mol or more, such as 94,000 g/mol or more, such as 98,000 g/mol or more, such as 102,000 g/mol or more, such as 106,000 g/mol or more. The weight average molecular weight may be 120,000 g/mol or less, such as 116,000 g/mol or less, such as 112,000 g/mol or less, such as 108,000 g/mol or less, such as 104,000 g/mol or less, 100,000 g/mol or less, such as 96,000 g/mol or less, such as 92,000 g/mol or less, such as 88,000 g/mol or less, such as 84,000 g/mol or less, such as such as 82,000 g/mol or less, such as 78,000 g/mol or less, such as 74,000 g/mol or less, such as 70,000 g/mol or less, such as 66,000 g/mol or less, such as 62,000 g/mol or less, such as 58,000 g/mol or less, such as 58,000 g/mol or less, such as 56,000 g/mol or less, such as 54,000 g/mol or less, such as 52,000 g/mol or less. The weight average molecular weight may be determined using means generally known in the art, such as gel permeation chromatography.

As indicated herein, the weight average molecular weight may be reduced due to the processing. In this regard, the weight average molecular weight of the final thermoplastic copolyester elastomer (or spun thermoplastic copolyester elastomer or processed thermoplastic copolyester elastomer) may be 98% or less, such as 97% or less, such as 95% or less, such as 93% or less, such as 90% or less, such as 87% or less, such as 85% or less, such as 83% or less, such as 80% or less, such as 77% or less, such as 75% or less, such as 73% or less of the weight average molecular weight of the initial thermoplastic copolyester elastomer. The weight average molecular weight of the final thermoplastic copolyester elastomer (or spun thermoplastic copolyester elastomer or processed thermoplastic copolyester elastomer) may be 50% or more, such as 53% or more, such as 55% or more, such as 57% or more, such as 60% or more, such as 63% or more, such as 65% or more, such as 67% or more, such as 70% or more, such as 73% or more, such as 75% or more, such as 77% or more, such as 80% or more, such as 83% or more, such as 85% or more, such as 87% or more, such as 90% or more, such as 93% or more, such as 95% or more of the weight average molecular weight of the initial thermoplastic copolyester elastomer.

In other words, the weight average molecular weight of the initial thermoplastic copolyester elastomer may be reduced, due to the processing, by 3% or more, such as 5% or more, such as 7% or more, such as 10% or more, such as 15% or more, such as 20% or more, such as 25% or more, such as 30% or more, such as 35% or more. The weight average molecular weight of the initial thermoplastic copolyester elastomer may be reduced 50% or less, such as 45% or less, such as 40% or less, such as 35% or less, such as 30% or less, such as 25% or less, such as 20% or less, such as 17% or less, such as 15% or less, such as 13% or less, such as 10% or less, such as 8% or less, such as 6% or less.

Accordingly, the final thermoplastic copolyester elastomer (or spun thermoplastic copolyester elastomer or processed thermoplastic copolyester elastomer) may have a weight average molecular weight of 40,000 g/mol or more, such as 42,000 g/mol or more, such as 44,000 g/mol or more, such as 46,000 g/mol or more, such as 48,000 g/mol or more, such as 50,000 g/mol or more, such as 52,000 g/mol or more, such as 54,000 g/mol or more, such as 56,000 g/mol or more, such as 58,000 g/mol or more, such as 60,000 g/mol or more, such as 62,000 g/mol or more, such as 64,000 g/mol or more, such as 66,000 g/mol or more, such as 68,000 g/mol or more, such as 70,000 g/mol or more, such as 72,000 g/mol or more, such as 74,000 g/mol or more, such as 76,000 g/mol or more, such as 78,000 g/mol or more, such as 80,000 g/mol or more, such as 82,000 g/mol or more. The weight average molecular weight may be 100,000 g/mol or less, such as 96,000 g/mol or less, such as 92,000 g/mol or less, such as 88,000 g/mol or less, such as 84,000 g/mol or less, such as 80,000 g/mol or less, such as 78,000 g/mol or less, such as 76,000 g/mol or less, such as 74,000 g/mol or less, such as 72,000 g/mol or less, such as 70,000 g/mol or less, such as 68,000 g/mol or less, such as 66,000 g/mol or less, such as 64,000 g/mol or less, such as 62,000 g/mol or less, such as 60,000 g/mol or less, such as 58,000 g/mol or less, such as 56,000 g/mol or less, such as 54,000 g/mol or less, such as 52,000 g/mol or less, such as 50,000 g/mol or less. Regardless, such weight average molecular weight of the final thermoplastic copolyester elastomer (or spun thermoplastic copolyester elastomer or processed thermoplastic copolyester elastomer) is less than the weight average molecular weight of the initial thermoplastic copolyester elastomer. Further, the weight average molecular weight may be determined using means generally known in the art, such as gel permeation chromatography.

Various embodiments of the present disclosure will now be described in more detail.

### I. Thermoplastic Copolyester Elastomer Composition

As indicated herein, the method is directed to making a thermoplastic copolyester elastomer-based fiber using a thermoplastic copolyester elastomer. In one embodiment, such fibers may be made from a thermoplastic copolyester elastomer composition comprising a thermoplastic copolyester elastomer. In addition, the thermoplastic copolyester elastomer composition may also include other additives as generally known in the art.

### A. Thermoplastic Copolyester Elastomer

As indicated above, the thermoplastic copolyester elastomer-based fiber and the thermoplastic copolyester elastomer composition include a thermoplastic copolyester elastomer. For instance, the thermoplastic copolyester elastomer composition may include one or more thermoplastic copolyester elastomers. The thermoplastic copolyester elastomer may be a thermoplastic copolyetherester elastomer and/or a thermoplastic copolyesterester elastomer. In one embodiment, the thermoplastic copolyester elastomer may be a thermoplastic copolyesterester elastomer. In one particular embodiment, the thermoplastic copolyester elastomer may be a thermoplastic copolyetherester elastomer.

As indicated above, the thermoplastic copolyester elastomer may be a copolyesterester elastomer. In general, a copolyesterester elastomer is a block copolymer containing (a) a hard polyester segment and (b) a soft polyester segment. Examples of hard polyester segments include, but are not limited to, polyalkylene terephthalates, poly(cyclohexanedicarboxylic acid cyclohexanemethanol), etc. and the like. Examples of soft polyester segments include, but are not limited to, aliphatic polyesters including, but not limited to, polybutylene adipate, polytetramethyladipate and polycaprolactone, etc.

The copolyesterester elastomer may contain one or more blocks of ester units of a high melting polyester and one or more blocks of ester units of a low melting polyester which are linked together through ester groups or urethane groups. Copolyesterester elastomers comprising urethane groups may be prepared by reacting the different polyesters in the molten phase, after which the resulting copolyesterester is reacted with a low molecular weight polyisocyanate. The polyisocyanate may be a diisocyanate or a triisocyanate. In particular, the polyisocyanate may be a diisocyanate, such as a paratoluene diisocyanate, diphenylmethane diisocyanate, xylylene diisocyanate, hexamethylene diisocyanate, and/or isophorone diisocyanate.

As indicated above, the thermoplastic copolyester elastomer may be a copolyetherester elastomer. In general, a copolyetherester elastomer may have a multiplicity of recurring long-chain ester units and short-chain ester units joined head-to-tail through ester linkages. The long-chain ester units can be represented by formula (A):

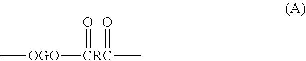

and the short-chain ester units can be represented by formula (B):

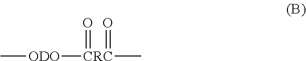

wherein
G is a divalent radical remaining after the removal of the terminal hydroxyl groups from a long chain polymeric glycol having a number average molecular weight of between about 400 and about 6000, preferably between about 400 and about 3000, even more preferably between about 600 and about 3000;
R is a divalent radical remaining after removal of carboxyl groups from a dicarboxylic acid having a number average molecular weight of less than about 300; and
D is a divalent radical remaining after removal of hydroxyl groups from a diol having a number average molecular weight of less than about 250.

As used herein, the term “long-chain ester units” refers to the reaction product of a long-chain glycol with a dicarboxylic acid. The long chain glycols are polymeric glycols having terminal (or nearly terminal as possible) hydroxyl groups. In particular, suitable long-chain glycols include poly(alkylene oxide) glycols having terminal (or as nearly terminal as possible) hydroxyl groups and having a number average molecular weight of from about 400 to about 6000, such as from about 400 to about 3000, such as from about 600 to about 3000, such as from about 1000 to about 3000, such as from about 1000 to about 2000. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol (e.g., 1,2- or 1,3-propylene oxide), poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. In addition, it should be understood that a mixture of two or more of these glycols may also be utilized. Also, any substituent groups can be present which do not interfere with polymerization of the compound with glycol(s) or dicarboxylic acid(s), as the case may be. The hydroxyl functional groups of the long chain glycols which react to form the copolyester can be terminal groups to the extent possible. The terminal hydroxyl groups can be placed on end capping glycol units different from the chain (e.g., ethylene oxide end groups on poly(propylene oxide glycol). Long chain ester units of Formula (A) may also be referred to as “soft segments” of a copolyetherester elastomer.

As used herein, the term “short-chain ester units” refers to low molecular weight compounds or polymer chain units having a number average molecular weight of less than about 550, such as less than about 525, such as less than about 500, such as less than about 475, such as less than about 450. They can generally be made by reacting a low molecular weight diol or a mixture of diols (molecular weight below about 250, such as below about 225, such as below about 200, such as below about 175, such as below about 150) with a dicarboxylic acid to form ester units represented by Formula (B) above. Short chain ester units of Formula (B) may also be referred to as “hard segments” of the copolyetherester polymer.

Included among the low molecular weight diols which react to form short-chain ester units for preparing copolyesters are acyclic, alicyclic and aromatic dihydroxy compounds. These compounds include diols with about 2 to about 15 carbon atoms, such as about 2 to about 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy)diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol or resorcinol diacetate can be used in place of resorcinol).

As used herein, the term “diols” includes equivalent ester-forming derivatives such as those mentioned. However, the molecular weight requirements refer to the corresponding diols and not their derivatives.

The dicarboxylic acids that can react with the aforementioned long-chain glycols and low molecular weight diols to produce the copolyetheresters may include aliphatic, cycloaliphatic or aromatic dicarboxylic acids of a low molecular weight (e.g., having a molecular weight of less than about 300, such as less than about 275, such as less than about 250, such as less than about 225). The term “dicarboxylic acids” as used herein includes functional equivalents of dicarboxylic acids that have two carboxyl functional groups that perform substantially like dicarboxylic acids in reaction with glycols and diols in forming thermoplastic copolyetherester elastomers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights. The dicarboxylic acid can contain any substituent groups or combinations that do not substantially interfere with thermoplastic copolyetherester elastomer formation and use of the thermoplastic copolyetherester elastomer in the composition.

As used herein, the term “aliphatic dicarboxylic acids” refers to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

As used herein, the term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; 3,4-furan dicarboxylic acid; and mixtures thereof. In one embodiment, the preferred acid may include a cyclohexane dicarboxylic acid and/or adipic acid.

Representative aromatic dicarboxylic acids that can be used include, but are not limited to, phthalic, terephthalic and isophthalic acids; dibenzoic acid; substituted dicarboxy compounds with two benzene nuclei such as bis(p-carboxyphenyl) methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives; and mixtures thereof. Hydroxy acids such as p-(beta-hydroxyethoxy)benzoic acid can also be used, provided an aromatic dicarboxylic acid is also used.

In one embodiment, an aromatic dicarboxylic acid is preferred for preparing thermoplastic copolyetherester elastomers. Among the aromatic dicarboxylic acids, those with 8 to 16 carbon atoms, such as 8 to 12 carbon atoms, such as 8 to 10 caron atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyetherester, isophthalic acid may be a preferred second dicarboxylic acid in one embodiment. For instance, isophthalic acid may be provided in a mixture with terephthalic acid. In this regard, the amount of copolymerized isophthalate residues in the copolyetherester may be less than 35 mole %, such as less than 30 mole %, such as less than 25 mole %. Similarly, copolymerized isophthalate residues in the copolyetherester may be less than 35 wt. %, such as less than 30 wt. %, such as less than 25 wt. %, based on the total weight of copolymerized dicarboxylic acid residues -(—C(O)RC(O)—)- in the copolyetherester. The remainder of the phenylene diradicals may be derived from terephthalic acid based on the total number of moles of copolymerized dicarboxylic acid residues -(—C(O)RC(O)—)- in the copolyetherester.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, the copolyetherester may have hard segments composed of polybutylene terephthalate and about 5 wt. % to about 80 wt. %, such as about 5 wt. % to about 75 wt. %, such as about 10 wt. % to about 70 wt. %, such as about 10 wt. % to about 60 wt. %, such as about 20 wt. % to about 60 wt. %, of soft segments composed of the reaction product of a polyether glycol and an aromatic diacid. The polyether blocks may be derived from polytetramethylene glycol. Complementarily, the fraction of hard segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred thermoplastic copolyetherester elastomers include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the thermoplastic copolyetherester elastomers may be prepared from esters or mixtures of esters of terephthalic acid or isophthalic acid, 1,4-butanediol and poly(tetramethylene ether)glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide)glycol). More preferably, the thermoplastic copolyetherester elastomers may be prepared from esters of terephthalic acid (e.g., dimethylterephthalate), 1,4-butanediol and poly(tetramethylene ether)glycol.

For instance, in one particular embodiment, the thermoplastic copolyetherester elastomer may have the following formula: -[4GT]ₓ-[BT]_{y}-, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the thermoplastic copolyetherester elastomer can be a block copolymer of polybutylene terephthalate and polyether segments and can have a structure as follows:

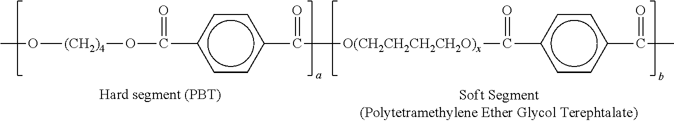

wherein a and b are integers and can vary from 2 to 10,000. The ratio between hard segments and soft segments in the block copolymer as described above can be varied in order to vary the properties of the elastomer.

In general, the thermoplastic copolyetherester elastomer preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of long-chain ester units corresponding to Formula (A) above (hard segments). The thermoplastic copolyetherester elastomer preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of long-chain ester units corresponding to Formula (A) above (hard segments).

In general, the thermoplastic copolyetherester elastomer preferably comprises about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of short-chain ester units corresponding to Formula (B) above (soft segments). The thermoplastic copolyetherester elastomer preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of short-chain ester units corresponding to Formula (B) above (soft segments).

In one embodiment, the thermoplastic copolyetherester elastomer may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyetherester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyetherester copolymer may be complementary. That is, the sum of the mole percentages of the R groups in the copolymerized units of Formula (A) and Formula (B) may be 100 mol %.

Furthermore, it should be understood that a mixture of two or more thermoplastic copolyester elastomers, in particular thermoplastic copolyetherester elastomers, can be used. In one embodiment, the composition may contain one thermoplastic copolyester elastomer as defined herein. In other embodiments, the composition may include a mixture of thermoplastic copolyester elastomers. For instance, more than one thermoplastic copolyester elastomer, such as two or three thermoplastic copolyester elastomers, may be utilized in the composition.

Specifically, regarding the thermoplastic copolyester elastomers, in particular a mixture of thermoplastic copolyetherester elastomers, each elastomer used need not on an individual basis come within the values set forth above for the elastomers. In this regard, the mixture of two or more thermoplastic copolyetherester elastomers may conform to the values described herein for the copolyetheresters on a weighted average basis, however. For example, in a mixture that contains equal amounts of two thermoplastic copolyetherester elastomers, one thermoplastic copolyetherester elastomer can contain 60 weight percent short-chain ester units and the other resin can contain 30 weight percent short-chain ester units for a weighted average of 45 weight percent short-chain ester units.

In addition, the thermoplastic copolyester elastomer, initial and/or final, may have a particular structure. For instance, in one embodiment, the thermoplastic copolyester elastomer may be linear. In another embodiment, the thermoplastic copolyester elastomer may be branched. For instance, in certain embodiments, the thermoplastic copolyester elastomer may be formed such that monomeric units form off the side chains of the elastomer thereby forming a branched structure.

Regarding the properties of the thermoplastic copolyester elastomer, it may be desired to have a melt flow that can allow it to be processed in a relatively easy manner for the formation of a composition and resulting part/article as disclosed herein. In this regard, the thermoplastic copolyester elastomer may exhibit a relatively low melt viscosity as indicated by the melt flow rate. For instance, the melt flow rate of the thermoplastic copolyester elastomer may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 7 g/10 min or more, such as about 8 g/10 min or more, such as about 10 g/10 min or more. The melt flow rate may be about 20 g/10 min or less, such as about 18 g/10 min or less, such as about 15 g/10 min or less, such as about 13 g/10 min or less, such as about 10 g/10 min or less, such as about 9 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133. Such property may apply to the initial thermoplastic copolyester elastomer and/or the final thermoplastic copolyester elastomer (or spun thermoplastic copolyester elastomer or processed thermoplastic copolyester elastomer).

The thermoplastic copolyester elastomer may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 230° C. or more, such as about 220° C. or more, such as about 250° C. or more. The melting temperature may be about 300° C. or less, such as about 280° C. or less, such as about 270° C. or less, such as about 260° C. or less, such as about 250° C. or less, such as about 240° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min. Such property may apply to the initial thermoplastic copolyester elastomer and/or the final thermoplastic copolyester elastomer (or spun thermoplastic copolyester elastomer or processed thermoplastic copolyester elastomer).

In addition, the glass transition temperature of the thermoplastic copolyester elastomer, in particular the thermoplastic copolyester elastomer, may be within a particular range. For instance, the glass transition temperature may be about −80° C. or more, such as about −70° C. or more, such as about −60° C. or more, such as about −50° C. or more, such as about −40° C. or more, such as about −30° C. or more. The glass transition temperature may be about 0° C. or less, such as about −5° C. or less, such as about −10° C. or less, such as about −20° C. or less, such as about −30° C. or less, such as about −40° C. or less. Also, the glass transition temperature of the hard segment of the thermoplastic copolyester elastomer may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min. Such property may apply to the initial thermoplastic copolyester elastomer and/or the final thermoplastic copolyester elastomer (or spun thermoplastic copolyester elastomer or processed thermoplastic copolyester elastomer).

Also, the thermoplastic copolyester elastomer may also have a relatively low Vicat softening temperature. For instance, the Vicat softening temperature may be about 70° C. or more, such as about 80° C. or more, such as about 90° C. or more, such as about 100° C. or more, such as about 110° C. or more, such as about 130° C. or more, such as about 150° C. or more, such as about 170° C. or more. The Vicat softening temperature may be about 250° C. or less, such as about 230° C. or less, such as about 210° C. or less, such as about 200° C. or less, such as about 180° C. or less, such as about 160° C. or less, such as about 140° C. or less, such as about 120° C. or less. The Vicat softening temperature may be determined using means known in the art, such as in accordance with ISO 306:2022 (rate of 50° C./h, 10 N). Such property may apply to the initial thermoplastic copolyester elastomer and/or the final thermoplastic copolyester elastomer (or spun thermoplastic copolyester elastomer or processed thermoplastic copolyester elastomer).

Further, the thermoplastic copolyester elastomer may have a particular density. For instance, the density be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The thermoplastic copolyester elastomer may have a density of about 2 g/cm³ or less, such as about 1.8 g/cm³ or less, such as about 1.6 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019. Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

In addition, the thermoplastic copolyester elastomer utilized may exhibit a certain mechanical strength. In particular, the thermoplastic copolyester elastomer may not be as likely to resist deformation in bending compared to other types of materials and as a result, the thermoplastic copolyester elastomer may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C. Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

Relatedly, the thermoplastic copolyester elastomer may have a particular Shore D hardness, which can provide an indication of the resistance to indentation of the thermoplastic copolyester elastomer. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 70 or less, such as 65 or less, such as 60 or less, such as about 55 or less, such as about 50 or less, such as about 45 or less, such as about 40 or less, such as about 35 or less, such as about 30 or less. Such hardness may allow for the thermoplastic copolyester elastomer to provide the compliance necessary to effectively function for use in a particular application. The Shore D hardness may be determined in accordance with ISO 868-2003 (15 seconds). Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

In addition, the thermoplastic copolyester elastomer may have other beneficial mechanical properties. For instance, the tensile stress at break may be about 50 MPa or less, such as about 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C. Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

Also, the thermoplastic copolyester elastomer may have a relatively high strain at break. The strain at break may be about 200% or more, such as about 225% or more, such as about 250% or more, such as about 275% or more, such as about 300% or more, such as about 325% or more, such as about 350% or more, such as about 375% or more, such as about 400% or more, such as about 450% or more, such as about 500% or more, such as about 600% or more, such as about 800% or more, such as about 1000% or more. The strain at break may be about 2000% or less, such as about 1800% or less, such as about 1600% or less, such as about 1400% or less, such as about 1200% or less, such as about 1000% or less, such as about 900% or less, such as about 800% or less, such as about 700% or less, such as about 600% or less, such as about 550% or less, such as about 500% or less, such as about 475% or less, such as about 450% or less, such as about 425% or less, such as about 400% or less, such as about 375% or less. The strain at break may be determined in accordance with ISO 527-1/-2 (2012) at a temperature of about 23° C. Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

Also, the thermoplastic copolyester elastomer may have a relatively high nominal strain at break. For instance, the nominal strain at break may be about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less. The nominal strain at break may be determined in accordance with ISO 527-1/-2 (2012) at a temperature of about 23° C. Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

Further, the tensile modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The tensile modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The tensile modulus may be determined in accordance with ISO 527-1/-2 (2012) at a temperature of about 23° C. Such property may apply to the initial thermoplastic copolyester elastomer and/or the final thermoplastic copolyester elastomer (or spun thermoplastic copolyester elastomer or processed thermoplastic copolyester elastomer). In one embodiment, such property may apply to a respective thermoplastic copolyester composition, for example an initial or spun/processed composition.

The thermoplastic copolyester elastomer composition may generally comprise about 3 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 98 wt. % or more, such as about 99 wt. % or more of the thermoplastic copolyester elastomer based on the weight of the thermoplastic copolyester elastomer composition. The thermoplastic copolyester elastomer composition may comprise 100 wt. % or less, such as about 99 wt. % or less, such as about 98 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less of the thermoplastic copolyester elastomer based on the weight of the thermoplastic copolyester elastomer composition. In another embodiment, the aforementioned weight percentages may be based on the weight of the thermoplastic copolyester elastomer-based fiber.

### B. Additives

In addition to the thermoplastic copolyester elastomer, the thermoplastic copolyester elastomer-based fiber and the thermoplastic copolyester elastomer composition may optionally comprise one or more additives, such as those mentioned below. In this regard, in one embodiment, the thermoplastic copolyester elastomer composition may further comprise one or more additives. For instance, the additives may include those typically utilized in the art in order to provide a resulting composition or material (e.g., fiber/filament, yarn, fabric, and/or article) having the desired properties. These additives may include, but are not limited to, fillers (e.g., fibrous fillers), reinforcing agents, process aids, plasticizers, stabilizers (e.g., heat stabilizers; UV light stabilizers; metal deactivators; antioxidants such as phenolic, phosphite, and/or amine containing antioxidants; etc.), viscosity modifiers, nucleating agents, lubricants, flow enhancing additives, flame retardants (e.g., phosphates such as polyphosphates, pyrophosphates, etc.; phosphinates; etc.), impact modifiers, antistatic agents, antimicrobial agents, colorants, pigments, etc.

When utilized, the respective additive may be present in the thermoplastic copolyester elastomer composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more based on the weight of the thermoplastic copolyester elastomer composition. The respective additive may be present in the thermoplastic copolyester elastomer composition in an amount of about 20 wt. % or less, such as about 15 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the thermoplastic copolyester elastomer composition. In another embodiment, the aforementioned weight percentages may be based on the weight of the thermoplastic copolyester elastomer in the thermoplastic copolyester elastomer composition. In one embodiment, the aforementioned weight percentages may be based on the weight of the thermoplastic copolyester elastomer-based fiber. In addition, it should be understood that in one embodiment, a respective additive may be present in the thermoplastic copolyester elastomer composition in an amount of 0 wt. %.

### II. Composition Formation

The thermoplastic copolyester elastomer composition described herein can be processed using techniques generally known in the art. For instance, the components (thermoplastic copolyester elastomer and optional additives) may be melt-mixed (also referred to as melt-blended). Utilizing such an approach, the components may be well-dispersed throughout the composition. Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, such as a Banbury™ mixer or a Brabender™ mixer, an extruder, such as a co-rotating extruder, a counter-rotating extruder, or a twin-screw extruder, a co-kneader, such as a Buss® kneader, etc. The melt blending may be carried out at a temperature ranging from 100 to 300° C. For instance, the temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 230° C. or more, such as about 220° C. or more, such as about 250° C. or more. The temperature may be about 300° C. or less, such as about 280° C. or less, such as about 270° C. or less, such as about 260° C. or less, such as about 250° C. or less, such as about 240° C. or less, such as about 230° C. or less, such as about 210° C. or less, such as about 200° C. or less, such as about 180° C. or less, such as about 160° C. or less, such as about 140° C. or less, such as about 120° C. or less.

However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation, such as a spinneret for forming fibers (interchangeably referred to as filaments) and yarns as disclosed herein. In particular, once formed, the thermoplastic copolyester elastomer composition may be utilized to form fibers (or filaments) and yarns as further described herein.

### III. Fibers and Yarns

As indicated herein, the thermoplastic copolyester elastomer and corresponding composition are suitable for forming fibers and corresponding yarns. While the thermoplastic copolyester elastomer and corresponding composition may be utilized to form short fiber yarns, in one particular embodiment, they may be utilized to form continuous fibers (or filaments) and corresponding yarns. In particular, the properties of the thermoplastic copolyester elastomer allow it to be processed to form fibers/filaments at speeds and conditions as disclosed herein and thereafter allow the fibers/filaments to be processed to form yarns and resulting fabrics and articles.

Furthermore, in one embodiment, the yarn may be a monofilament (or monofiber) yarn. In this regard, the yarn may simply be formed from the thermoplastic copolyester elastomer and/or corresponding composition. In another embodiment, the yarn may be a multifilament (or multifiber) yarn. In this regard, a first fiber may be formed from the thermoplastic copolyester elastomer and/or corresponding composition. Alternatively, a first fiber may be formed from a fiber-forming material. In addition, a second fiber of the yarn may be formed from the thermoplastic copolyester elastomer and/or corresponding composition.

The fiber-forming material of the first fiber may be any material generally known in the art for forming fibers/filaments and yarns. In one embodiment, it may be an elastic material. In another embodiment, it may be a non-elastic material. In one embodiment, the first-forming material may not be a thermoplastic copolyester elastomer. In this regard, the fiber-forming material may be a non-thermoplastic copolyester elastomer. The fiber-forming material may be cellulosic (e.g., cotton, bamboo), proteinaceous (e.g., wool, silk, and soybean), polyester (e.g., polyethylene terephthalate, polytrimethylene terephthalate), polyamide (e.g., nylon, polycaprolactam, poly(hexamethylene adipamide), aramid), acrylic, acetate, rayon, etc. Further, the fiber-forming material may be a thermoplastic in one embodiment, such that it has a glass transition temperature and/or a melting temperature. In another embodiment, the fiber-forming material may be a thermoset such that it has a degradation temperature.

The resulting yarns may include a thermoplastic copolyester elastomer-based fibers in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the yarn. The thermoplastic copolyester elastomer-based fibers may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the yarn.

The fibers/filaments of the present disclosure can be made using general processes. For example, these processes may include steps such as spinning and optionally drawing the thermoplastic copolyester elastomer composition, including the thermoplastic copolyester elastomer, into a fiber/filament. The fibers/filaments may also be treated mechanically and/or chemically (e.g., via finishes) to impart desirable characteristics such as strength, elasticity, heat resistance, feel, etc. depending on the desired properties and characteristics of the resulting article made from the fibers/filaments and yarns.

In addition, one or more processing steps may allow for a reduction in the number average molecular weight of the thermoplastic copolyester elastomer as well as one or more additional mechanical properties of the thermoplastic copolyester elastomer and/or resulting fiber/filament formed from such initial thermoplastic copolyester elastomer (or corresponding composition) and spun/processed thermoplastic copolyester elastomer (or corresponding composition).

In one particular embodiment, the fibers/filaments may be formed via melt spinning. Accordingly, the fibers/filaments may be melt spun fibers/filaments. Generally, melt spinning includes heating the thermoplastic copolyester elastomer and corresponding composition including the thermoplastic copolyester elastomer to form a melt (also referred to as an elastomer melt) wherein such melting can be conducted by heating the thermoplastic copolyester elastomer against a heated surface. As an example, the thermoplastic copolyester elastomer may be heated in a mixer or an extruder and thereafter provided or metered to a spinneret. The temperature of operation may correspond to the melting temperature of the thermoplastic copolyester elastomer; for instance, the temperature may be relatively higher than the melting temperature of the thermoplastic copolyester elastomer in order to allow for the formation of an elastomer melt. Regardless, the operation temperature may be within the ranges of the melting temperature of the thermoplastic copolyester elastomer as defined above. For instance, the temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 230° C. or more, such as about 220° C. or more, such as about 250° C. or more. The temperature may be about 300° C. or less, such as about 280° C. or less, such as about 270° C. or less, such as about 260° C. or less, such as about 250° C. or less, such as about 240° C. or less, such as about 230° C. or less, such as about 210° C. or less, such as about 200° C. or less, such as about 180° C. or less, such as about 160° C. or less, such as about 140° C. or less, such as about 120° C. or less.

The spinneret may include a plurality of orifices or capillaries having a particular size and design that allows for the formation of a fiber/filament having the desired configuration and cross-section. Accordingly, this process allows fibers/filaments of various sizes and cross sections to be formed, including fibers/filaments having, for example, round, elliptical, square, rectangular, lobed or dog-boned cross sections, etc.

Once extruded through the spinneret, the fibers/filaments may be quenched. For instance, the fibers/filaments can be contacted with a non-reactive gas stream (e.g., air) or a liquid (e.g., water) to assist in solidifying the fibers/filaments. As an example, a fiber/filament may be quenched while traversing in a general vertical direction using a non-reactive gas stream, such as air. In another embodiment, a fiber/filament may be quenched while traversing in a relatively horizontal direction through a liquid. In addition, in one embodiment, additional quenching may not be necessary and sufficient quenching may be conducted based on ambient conditions. Thereafter, the fibers/filaments are collected downstream from the spinneret using a guide and can be taken up by a roller or a plurality of rollers.

The thermoplastic copolyester elastomer can be spun at speeds of from about 200 to about 6000 meters per minute (m/min), depending on the desired fiber/filament size. When forming the fibers/filaments, the spinning speed may be at least about 200 m/min, such as at least about 300 m/min, such as at least about 400 m/min, such as at least about 500 m/min, such as at least about 600 m/min, such as at least about 800 m/min, such as at least about 1000 m/min, such as at least about 2000 m/min. The spinning speed may be about 6000 m/min or less, such as about 5000 m/min or less, such as about 4000 m/min or less, such as about 3000 m/min or less, such as about 2500 m/min or less, such as about 2000 m/min or less, such as about 1800 m/min or less, such as about 1600 m/min or less, such as about 1400 m/min or less, such as about 1200 m/min or less, such as about 1000 m/min or less, such as about 800 m/min or less, such as about 600 m/min or less.

In addition, a finish may be applied to the fibers/filaments. The finish may be applied for facilitating spinning and/or subsequent processing. For instance, the finish may be applied to impart lubrication thereby minimizing friction. The finish generally includes an oil (finish oil). In this regard, the finish oil may include, but is not limited to, a silicone oil, a mineral oil, an ester oil, and the like as well as mixtures thereof. In one embodiment, the finish oil may include a silicone oil. In another embodiment, the finish oil may include a mineral oil. In a further embodiment, the finish oil may include an ester oil. However, it should be understood that other finish oils utilized for thermoplastic copolyester elastomers may also be utilized. In addition, the finish may also include other additives generally utilized in the art. In this regard, the finish may include a salt of a fatty acid, in particular a metal salt of a fatty acid. For instance, the fatty acid salt may be a stearate in one embodiment. Accordingly, these additives within the finish may include, but are not limited to, sodium palmitate, sodium stearate, magnesium stearate, potassium stearate, potassium palmitate, potassium myristate, sodium myristate, calcium stearate, calcium laurate, zinc stearate, and mixtures thereof.

Such application of finish may be conducted before drawing an undrawn fiber/filament, if drawing such fiber/filament. In addition, it may be done after quenching. In one embodiment, such application may be conducted during quenching; in such instance, the fiber/filament and/or yarn may have a crimp, such as a helical crimp.

Following extrusion from the spinneret, the fiber/filament may be drawn. The drawing may assist with achieving desirable properties, such as increasing amorphous orientation, shrinkage, modulus, and/or strength. However, it should be understood that in certain embodiments, drawing may not be conducted such that the fiber/filament produced is an undrawn fiber/filament. In such embodiments, the fiber/filament may still nonetheless have certain desirable properties. When conducted, the drawing can be done in combination with take-up by using a series of rollers or pins, some of which may be generally heated, or it can be done as a separate stage in the process of the fiber/filament formation. If heated, the drawing can be carried out at about 15° C.-150° C., such as from about 15° C.-130° C., such as from about 15° C.-100° C., such as from about 15° C.-80° C., such as from about 15° C.-60° C., such as from about 15° C.-40° C.

The godet roll speed, typically between a feed roll and a winding roll and which may be utilizing for drawing under certain conditions, may be from about 200 to about 6000 meters per minute (m/min). For instance, the speed may be at least about 200 m/min, such as at least about 300 m/min, such as at least about 400 m/min, such as at least about 500 m/min, such as at least about 600 m/min, such as at least about 800 m/min, such as at least about 1000 m/min, such as at least about 1250 m/min, such as at least about 1500 m/min, such as at least about 1750 m/min, such as at least about 2000 m/min. The speed may be about 6000 m/min or less, such as about 5000 m/min or less, such as about 4000 m/min or less, such as about 3000 m/min or less, such as about 2750 m/min or less, such as about 2500 m/min or less, such as about 2250 m/min or less, such as about 2000 m/min or less, such as about 1800 m/min or less, such as about 1600 m/min or less, such as about 1400 m/min or less, such as about 1200 m/min or less, such as about 1000 m/min or less, such as about 800 m/min or less, such as about 600 m/min or less.

The fibers/filaments may be drawn at any desired draw ratio depending on the desired properties, short of that which interferes with processing by breaking a fiber/filament. In this regard, the fibers/filaments may be drawn from 0× to about 6×, such as from about 0.9× to about 6×, such as from about 1.1× to about 6×. For instance, the fibers/filaments may be drawn at 0× or more, such as at least about 0.2×, such as at least about 0.3×, such as at least about 0.5×, such as at least about 0.7×, such as at least about 0.9×, such as at least about 1.1×, such as at least bout 1.2×, such as at least about 1.3×, such as at least about 1.4×, such as at least about 1.5×, such as at least about 1.8×, such as at least about 2×, such as at least about 2.2×, such as at least about 2.4×, such as at least about 2.5×. The fibers/filaments may be drawn about 5× or less, such as about 4.5× or less, such as about 4× or less, such as about 3.5× or less, such as about 3× or less, such as about 2.8× or less, such as about 2.6× or less, such as about 2.4× or less, such as about 2.2× or less, such as about 2× or less. Such drawing may be conducted in a single step draw in one embodiment. In another embodiment, however, the fibers/filaments may not be drawn.

The resulting fiber/filament is also amenable to further processing through the use of additional processing equipment, or it may be used directly in applications requiring a continuous fiber/filament and/or yarn. Regarding further processing, the fiber/filament subsequently may be converted to a textured yarn through known false twist texturing conditions or other processes. It may also be desirable to increase the surface area of the fiber/filament to provide a softer feel and to enhance the ability of the fibers/filaments to breathe, thereby providing better insulation and water retention in the case of textiles. To increase the surface area, the fiber/filament may be crimped or twisted, such as by a false twist method, an air jet, an edge crimp, a gear crimp, a stuffer box, etc. for example. In the case of an elastomeric yarn, a “bulking” type process to heat the yarn with minimal tension may also be performed to allow the yarn to relax and shrink, which may increase the elongation to break and thermal stability by heat history of the yarn. The method utilized may be dictated by the particular application for the fiber/filament.

In addition, after formation, the fiber/filament may be treated by any method appropriate to the desired final use. For instance, in particular regarding textiles, this may include dyeing, coloring with pigments, sizing, or the addition of chemical agents such as antistatic agents, flame retardants, UV light stabilizers, antioxidants, pigments, dyes, stain resistants, and/or antimicrobial agents. In addition, the fibers/filaments may be treated to impart additional desired characteristics such as strength, elasticity or shrinkage. While the fibers/filaments and yarns may be treated using such techniques, it should be understood that the resulting article may also be treated using such techniques. Nevertheless, examples of suitable treatments and application methods are found in “Textile coloration and finishing,” by Warren S. Perkins, Carolina Academic Press, Durham, NC, 1996.

Thus, generally, the method of making a fiber/filament or a yarn, such as a monofilament yarn, as disclosed herein may include at least the following: extruding a melt comprising the thermoplastic copolyester elastomer composition comprising the thermoplastic copolyester elastomer through a spinneret; withdrawing a fiber/filament from the spinneret; and collecting the fiber/filament on a winding roller. In addition, the method may also comprise quenching the fiber/filament using air. Such quenching may be conducted before drawing, if drawing is conducted, the fiber/filament. Also, the method may comprise applying a finish to the fiber/filament. Such application may also be conducted before drawing, if drawing is conducted, the fiber/filament; in addition, it may be done after quenching. Also, the method may include a step of drawing the fiber/filament using a draw roller. Such drawing may be conducted after quenching and/or after applying a finish.

Further, generally, the method of making a multifilament yarn as disclosed herein may include at least the following: extruding a melt comprising the thermoplastic copolyester elastomer composition comprising the thermoplastic copolyester elastomer through a spinneret; withdrawing a first fiber/filament and a second fiber/filament from the spinneret; and collecting the first fiber/filament and the second fiber/filament on a winding roller. When a third fiber/filament (or more) is present, the aforementioned steps may be the same for forming the third fiber/filament. In addition, the method may also comprise quenching the first fiber/filament and the second fiber/filament using air. Such quenching may be conducted before drawing, if drawing is conducted, the fiber/filament. If present, quenching may also be conducted on a third fiber/filament. Also, the method may comprise applying a finish to the first fiber/filament and the second fiber/filament. Such application may also be conducted before drawing, if drawing is conducted, the fiber/filament; in addition, it may be done after quenching. If present, application of the finish may also be conducted on a third fiber/filament. Also, the method may include a step of drawing the first fiber/filament and the second fiber/filament using a draw roller. Such drawing may be conducted after quenching and/or after applying a finish. The method may also include a step of drawing a third fiber/filament, if present. In addition, the method of making the multifilament yarn may also include a step of converging the fibers/filaments to form the multifilament yarn.

However, it should be understood that other methods of making multifilament yarns as known in the art may also be utilized. For instance, such methods may be utilized when the fibers/filaments of the multifilament yarn are formed from different materials. For instance, as indicated here, the yarn may include a first fiber formed from a fiber-forming material and a second fiber formed from a thermoplastic copolyester elastomer. In this regard, separate monofilaments or fibers of the first fiber as mentioned above and a second fiber of the thermoplastic copolyester elastomer may be formed. Then, post formation, such respective fibers may be spun to form a respective multifilament yarn.

Further in accordance with the present disclosure, a melt spinning process is also disclosed for spinning fibers/filaments, in particular continuous fibers/filaments. In general, the process comprises passing a melt comprising a thermoplastic copolyester elastomer composition, including a thermoplastic copolyester elastomer, through a spinneret to form a plurality of stretchable, synthetic elastomeric fibers/filaments. A thermoplastic copolyester elastomer composition supply (e.g., in granular, pellet, or other form such as a melt) may be introduced to a spinneret. The molten fibers/filaments may be extruded through the spinneret. The elastomer may be extruded as undrawn fibers/filaments from the spinneret having orifices designed to give a desired cross section. In addition, the process may further include quenching the fibers/filaments after they exit the capillary of the spinneret to cool and/or solidify the fibers/filaments in any known manner, for example by cool air. Any suitable quenching method may be used, such as in-flow quenching, out-flow quenching, cross-flow quenching, and/or radial flow quenching.

These fibers/filaments can then be drawn if desired after quenching. The fibers/filaments may be drawn in at least one drawing step, for example between a feed roll (which can be operated at 150 to 1000 m/minute) and a draw roll to form a drawn fiber/filament. The drawing step can be coupled with spinning to make a drawn yarn. Drawing can also be accomplished during winding the fibers/filaments as a warp of yarns, referred to as “draw warping.” Herein, the draw ratio may be the draw roll peripheral speed divided by the feed roll peripheral speed.

The fiber/filament, which may or may not be drawn optionally can be partly relaxed, for example, with steam. Any amount of heat-relaxation can be carried out during spinning. In this regard, the fiber/filament may be dry or wet heat-treated while relaxed to develop the desired stretch/stiffness and recovery properties. Such relaxation can be accomplished during fiber/filament production, for example during the above-described relaxation step or after the fiber/filament has been incorporated into a yarn or a fabric, for example during scouring, dyeing, and the like. Heat-treatment in fiber/filament or yarn form can be carried out using hot rolls or a hot chest or in a jet-screen bulking step, for example. It may be preferred that such relaxed heat-treatment be performed after the fiber/filament is in a yarn or a fabric so that up to that time it can be processed like a non-elastomeric fiber/filament; however, if desired, it can be heat-treated and fully relaxed before being wound up as a fiber/filament. For greater uniformity in the final fabric, the fiber/filament can be uniformly heat-treated and relaxed. The heat-treating/relaxation temperature can be in the range of about 80° C. to about 150° C. when the heating medium is dry air or steam, about 75° C. to about 100° C. when the heating medium is hot water, and about 101° C. to about 115° C. when the heating medium is super atmospheric pressure steam. Generally, lower temperatures may result in too little or no heat-treatment and higher temperatures may melt the thermoplastic copolyester elastomer. Furthermore, the heat-treating/relaxation step can generally be accomplished in a few seconds. Without intending to be limited, generally, the greater the relaxation, the more elastic the fiber/filament and the less shrinkage that may occur in downstream operations. In addition, without intending to be limited, such treatment may also allow the resulting article (e.g., garment), fabric, and/or yarn to be thermally stable for post-treatment processes, such as screen printing, sublimation dyeing, etc.

In addition, relaxation of the fibers/filaments may be conducted by utilizing the rolls/rollers present within the process. For instance, as disclosed herein, the process may include a feed roller to which a fiber/filament may be withdrawn from the spinneret. The process may also include a draw roller or godet roller after the feed roller. Finally, the fiber/filament/yarn may be taken up by a winding roller. By controlling the speeds of the respective rollers, the fiber/filament and/or yarn may have an opportunity to relax. For instance, in one embodiment, the feed roller speed may be greater than a draw roller speed or if no drawing, a godet roller speed. In one embodiment, the draw roller speed or if no drawing, a godet roller speed may be greater than a winding roller speed. In a further embodiment, the feed roller speed may be greater than a draw roller speed or if no drawing, a godet roller speed and the draw roller speed or if no drawing, the godet roller speed may be greater than a winding roller speed.

The quenched, optionally drawn, and optionally relaxed fibers/filaments can then be collected by winding at the winder. The winder may also be referred to as a take up roll. The winding speed may be from about 200 to about 6000 meters per minute (m/min). For instance, the winding speed may be at least about 200 m/min, such as at least about 300 m/min, such as at least about 400 m/min, such as at least about 500 m/min, such as at least about 600 m/min, such as at least about 800 m/min, such as at least about 1000 m/min, such as at least about 1250 m/min, such as at least about 1500 m/min, such as at least about 1750 m/min, such as at least about 2000 m/min. The winding speed may be about 6000 m/min or less, such as about 5000 m/min or less, such as about 4000 m/min or less, such as about 3000 m/min or less, such as about 2750 m/min or less, such as about 2500 m/min or less, such as about 2250 m/min or less, such as about 2000 m/min or less, such as about 1800 m/min or less, such as about 1600 m/min or less, such as about 1400 m/min or less, such as about 1200 m/min or less, such as about 1000 m/min or less, such as about 800 m/min or less, such as about 600 m/min or less.

In one embodiment, the winding speed may be less than the draw (or godet) roll speed. For instance, the draw (or godet) roll speed may be 75% or more, such as 80% or more such as 85% or more, such as 88% or more, such as 90% or more, such as 92% or more, such as 94% or more, such as 95% or more, such as 96% or more, such as 97% or more, such as 97.5% or more, such as 98% or more, such as 98.5% or more, such as 99% or more to less than 100% of the winding speed. Without intending to be limited by theory, it is believed that such difference in speeds may allow for the fiber(s)/filament(s) and yarn to have an opportunity to at least partially relax.

If multiple fibers/filaments have been spun and quenched, the fibers/filaments can be converged, optionally interlaced, and then wound up. For instance, such convergence and/or interlacing may be conducted to form multifilament yarns. Single fiber/filament or multifilament yarns may be wound up at the winder in the same manner. Where multiple fibers/filaments have been spun and quenched, the fibers/filaments can be converged and optionally interlaced prior to winding as is done in the art. The convergence may occur at multiple points of the process. For example, the convergence may be at a feed roll or before a feed roll, such as at a finish applicator.

As indicated herein, the fibers/filaments may be utilized to make a yarn. A yarn may include, but is not limited to, a number of fibers/filaments twisted together (spun yarn), a number of fibers/filaments laid together without twist (a zero-twist yarn), a number of fibers/filaments laid together with a degree of twist, and a single fiber/filament with or without twist (a monofilament).

In one embodiment, a multifilament yarn as disclosed herein may have no twist. In another embodiment, the multifilament yarn as disclosed herein may have a relatively small degree of twist. For instance, the twist may be 1 or less twists per inch, such as 0.9 or less twists per inch, such as 0.8 or less twists per inch, such as 0.7 or less twists per inch, such as 0.6 or less twists per inch, such as 0.5 or less twists per inch, such as 0.4 or less twists per inch, such as 0.3 or less twists per inch, such as 0.2 or less twists per inch, such as 0.1 or less twists per inch, such as 0.05 or less twists per inch, such as 0.01 or less twists per inch. The twist may be 0 or more twists per inch, such as 0.01 or more twists per inch, such as 0.05 or more twists per inch, such as 0.1 or more twists per inch, such as 0.2 or more twists per inch, such as 0.3 or more twists per inch, such as 0.4 or more twists per inch, such as 0.5 or more twists per inch.

As indicated herein, the yarn may generally have any fiber/filament count. For instance, the yarn may be a monofilament yarn formed from a single fiber/filament. Alternatively, the yarn may be a multifilament yarn formed from two or more fibers/filaments wherein such two or more fibers/filaments may be wound to form the yarn. Accordingly, the multifilament yarn comprises a first fiber/filament and a second fiber/filament. In addition, the multifilament yarn may further comprise a third fiber/filament. In particular, the multifilament yarn may include a first fiber/filament, a second fiber/filament, and a third fiber/filament.

In this regard, the multifilament yarn may comprise at least about 2 fibers/filaments. The multifilament yarns may comprise about 2 or more, such as about 3 or more, such as about 5 or more, such as about 10 or more, such as about 15 or more, such as about 20 or more, such as about 25 or more, such as about 50 or more, such as about 100 or more fibers/filaments. The multifilament yarn may comprise about 200 or less, such as about 100 or less, such as about 80 or less, such as about 60 or less, such as about 50 or less, such as about 40 or less, such as about 35 or less, such as about 30 or less, such as about 25 or less, such as about 20 or less, such as about 15 or less, such as about 10 or less, such as about 5 or less, such as about 4 or less, such as about 3 or less fibers/filaments.

The yarns may have a total denier of from about 1 to about 2000. For instance, the total denier may be about 1 or more, such as about 5 or more, such as about 10 or more, such as about 20 or more, such as about 30 or more, such as about 40 or more, such as about 50 or more, such as about 70 or more, such as about 100 more, such as about 120 or more, such as about 140 or more, such as about 160 or more, such as about 180 or more, such as about 200 or more, such as about 300 or more, such as about 500 or more, such as about 800 or more, such as about 1000 or more, such as about 1300 or more, such as about 1500 or more, such as about 1800 or more, such as about 2000 or more. The total denier may be about 3000 or less, such as about 2800 or less, such as about 2500 or less, such as about 2200 or less, such as about 2000 or less, such as about 1800 or less, such as about 1600 or less, such as about 1400 or less, such as about 1200 or less, such as about 1000 or less, such as about 800 or less, such as about 600 or less, such as about 500 or less, such as about 450 or less, such as about 400 or less, such as about 350 or less, such as about 300 or less, such as about 275 or less, such as about 250 or less, such as about 225 or less, such as about 200 or less, such as about 180 or less, such as about 160 or less, such as about 140 or less, such as about 120 or less, such as about 100 or less, such as about 80 or less, such as about 60 or less, such as about 50 or less. The denier may be determined in accordance with D2259-02 (2016) at a temperature of about 23° C.

In addition, the yarn may have a particular linear density as it relates to the fibers/filaments that make up the yarn. For instance, the yarn may have at least about 0.1 denier per filament (or fiber) (dpf), such as at least about 0.2 dpf, such as at least about 0.5 dpf, such as at least about 0.7 dpf, such as at least about 1 dpf, such as at least about 2 dpf, such as at least about 3 dpf, such as at least about 4 dpf, such as at least about 5 dpf, such as at least about 8 dpf, such as at least about 10 dpf, such as at least about 20 dpf, such as at least about 30 dpf, such as at least about 50 dpf, such as at least about 70 dpf, such as at least about 90 dpf, such as at least about 110 dpf, such as at least about 130 dpf, such as at least about 150 dpf, such as at least about 200 dpf, such as at least about 300 dpf, such as at least about 500 dpf, such as at least about 800 dpf, such as at least about 1,000 dpf, such as at least about 1,200 dpf, such as at least about 1,400 dpf, such as at least about 1,600 dpf. The yarn may have about 2,000 dpf or less, such as about 1,700 dpf or less, such as about 1,500 dpf or less, such as about 1,300 dpf or less, such as about 1,100 dpf or less, such as about 900 dpf or less, such as about 700 dpf or less, such as about 500 dpf or less, such as about 450 dpf or less, such as about 400 dpf or less, such as about 350 dpf or less, such as about 300 dpf or less, such as about 250 dpf or less, such as about 200 dpf or less, such as about 180 dpf or less, such as about 150 dpf or less, such as 130 pdf or less, such as 110 dpf or less, such as 100 dpf or less, such as 90 dpf or less, such as 80 dpf or less, such as 70 dpf or less, such as 60 dpf or less, such as 50 or less dpf, such as about 40 or less dpf, such as about 35 or less dpf, such as about 30 or less dpf, such as about 25 or less dpf, such as about 22 or less dpf, such as about 20 or less dpf, such as about 18 or less dpf, such as about 16 or less dpf, such as about 14 or less dpf, such as about 12 or less dpf, such as about 10 or less dpf, such as about 8 or less dpf, such as about 6 or less dpf, such as about 5 or less dpf, such as about 4 or less dpf, such as about 3.5 or less dpf, such as about 3 or less dpf, such as about 2.5 or less dpf. In one embodiment, such aforementioned linear density may refer to a particular type of fiber (e.g., first fiber or second fiber) as defined herein. Without intending to be limited, the dpf may be relatively lower for certain applications than other applications. For instance, the dpf may be relatively lower for textile applications than for industrial applications. Regardless, the size and strength of such a fiber/filament can be readily determined using means generally known in the art.

In addition, due to the process and materials as disclosed herein, the fiber/filament may exhibit a desired elongation at break. For instance, the elongation at break may be 250% or more, such as 300% or more, such as 350% or more, such as 400% or more, such as 450% or more, such as 500% or more, such as 550% or more, such as 600% or more, such as 650% or more, such as 700% or more, such as 750% or more. The elongation at break may be 2000% or less, such as 1800% or less, such as 1600% or less, such as 1400% or less, such as 1200% or less, such as 1000% or less, such as 900% or less, such as 850% or less, such as 800% or less, such as 750% or less, such as 700% or less, such as 650% or less, such as 600% or less, such as 550% or less, such as 500% or less, such as 475% or less, such as 450% or less, such as 425% or less, such as 400% or less, such as 375% or less. The elongation at break may be determined in accordance with ASTM D2653-07 (2018).

The fiber/filament may also have a particular force at 50% strain. The force at 50% strain may be 2 g_{f} or more, such as 2.5 g_{f} or more, such as 3 g_{f} or more, such as 3.5 g_{f} or more, such as 4 g_{f} or more, such as 4.5 g_{f} or more, such as 5 g_{f} or more, such as 5.5 g_{f} or more, such as 6 g_{f} or more. The force at 50% strain may be 10 g_{f} or less, such as 9.5 g_{f} or less, such as 9 g_{f} or less, such as 8.5 gr or less, such as 8 g_{f} or less, such as 7.5 g_{f} or less, such as 7 g_{f} or less, such as 6.5 g_{f} or less, such as 6 g_{f} or less, such as 5.5 g_{f} or less, such as 5 g_{f} or less. The force at 50% strain may be determined in accordance with ASTM D2653-07 (2018). In one embodiment, such aforementioned force may be a 40d fiber/filament.

The fiber/filament may also have a particular force at 100% strain. The force at 100% strain may be 2 g_{f} or more, such as 2.5 g_{f} or more, such as 3 g_{f} or more, such as 3.5 g_{f} or more, such as 4 g_{f} or more, such as 4.5 g_{f} or more, such as 5 g_{f} or more, such as 5.5 g_{f} or more, such as 6 g_{f} or more. The force at 100% strain may be 12 g_{f} or less, such as 11 g_{f} or less, such as 10 g_{f} or less, such as 9.5 gr or less, such as 9 g_{f} or less, such as 8.5 g_{f} or less, such as 8 g_{f} or less, such as 7.5 g_{f} or less, such as 7 g_{f} or less, such as 6.5 g_{f} or less, such as 6 g_{f} or less, such as 5.5 g_{f} or less, such as 5 g_{f} or less. The force at 100% strain may be determined in accordance with ASTM D2653-07 (2018). In one embodiment, such aforementioned force may be a 40d fiber/filament.

The fiber/filament may also have a desired tenacity. For instance, the tenacity may be 0.5 gpd or more, such as 0.6 gpd or more, such as 0.7 gpd or more, such as 0.8 gpd or more, such as 0.9 gpd or more, such as 1 gpd or more, such as 1.1 gpd or more, such as 1.2 gpd or more, such as 1.3 gpd or more, such as 1.4 gpd or more, such as 1.5 gpd or more, such as 1.8 gpd or more, such as 2 gpd or more, such as 2.5 gpd or more, such as 3 gpd or more, such as 3.5 gpd or more, such as 4 gpd or more, such as 4.5 gpd or more, such as 5 gpd or more. The tenacity may be 10 gpd or less, such as 9 gpd or less, such as 8 gpd or less, such as 7 gpd or less, such as 6 gpd or less, such as 5 gpd or less, such as 4 gpd or less, such as 3 gpd or less, such as 2 gpd or less, such as 1.8 gpd or less, such as 1.6 gpd or less, such as 1.4 gpd or less, such as 1.2 gpd or less, such as 1.1 gpd or less, such as 1 gpd or less, such as 0.9 gpd or less, such as 0.8 gpd or less, such as 0.7 gpd or less. The tenacity may be determined using means generally known in the art, such as ASTM D2653-07 (2018).

### IV. Articles

The present inventors have discovered that the advantageous properties of the fiber/filament and/or yarn as disclosed herein can allow for it to be utilized to form various articles for various applications. In this regard, the fibers/filaments may be utilized to form yarns which may be used to prepare woven, knit, and/or nonwoven fabrics and resulting articles which can be prepared using conventional techniques including, but not limited to, meltblown, spunbonded, card and bond, including heat bonding (hot air and point bonding), air entanglement, and other techniques. For instance, they may be subjected to various high-speed conditions for the formation of such articles.

In addition, the configuration of the yarn may depend on the particular application. For instance, the yarn may be utilized as a bare yarn or a covered yarn. In one embodiment, the yarns may be utilized themselves as bare yarns. Alternatively, the yarns may be used as covered yarns wherein the yarn as described herein may be utilized as the core. For such covered yarn, an inelastic fiber/filament or yarn or a short fiber yarn may wrap the core, in particular in a spiral manner. In addition or alternatively, another elastic yarn may also be utilized to cover.

Further, the yarns may be utilized to make fabrics, such as knit fabrics or woven fabrics. As a result, the yarns may be considered knittable yarns, in particular knittable, stretchable yarns.

The knit construction of the fabrics using the yarns is not necessarily limited by the present disclosure. For instance, various types of knit constructions as known in the art may be utilized to form a fabric and/or resulting article utilizing the fibers/filaments and yarns as disclosed herein. As just certain examples, the knit construction may be one as disclosed in U.S. Pat. Nos. 9,689,092, 10,370,782, or US Patent Publication No. 2021/0254244, all of which are hereby incorporated in their entirety.

In one particular embodiment, the knit construction may be a circular knit construction. Without intending to be limited, articles formed from circular knit constructed fabrics may be more comfortable than other knit constructions partially due to the ability of the fabric to stretch, at least in selective areas. For instance, when a force is applied, the circular knit fabric may stretch slightly due to the compression and/or elongation that may occur among the stitches/loops of the fabric and then may recover.

Generally, knitting is a process for constructing a fabric by interlocking a series of loops (bights) of one or more strands organized in wales and courses. In general, knitting includes warp knitting and weft knitting. In warp knitting, a plurality of strands runs lengthwise in the fabric to make all the loops. In weft knitting, one continuous strand runs crosswise in the fabric, making all the loops in one course. Weft knitting includes fabrics formed on both circular knitting and flat knitting machines. With circular knitting machines, the fabric is produced in the form of a tube, with the strands running continuously around the fabric. With a flat knitting machine, the fabric is produced in flat form, the threads alternating back and forth across the fabric. The resulting textile includes an interior side (the technical back) and an exterior side (the technical face), each layer being formed of the same or varying strands and/or stitches. By way of example, the knit structure may be a single knit/jersey fabric, a double knit/jersey fabric, and/or a plated fabric (with yarns of different properties are disposed on the face and back).

The textile may be formed via weft knitting, where one continuous thread runs crosswise in the fabric making all of the loops in one course. Preferably, the weft knitted textile is formed via circular knitting, in which the textile is produced in the form of a tube, with the threads running continuously around the textile.

In one embodiment, the textile may possess a knit structure organized in courses and wales, each course being formed by a strand. The term “strand” includes a single yarn (a continuous strand of textile fiber(s)/filament(s) in a form suitable for knitting, weaving, or otherwise intertwining to form a textile fabric). In an embodiment, the knit structure includes a first strand. Such first strand may be a yarn as disclosed herein including a first fiber and a second fiber. The strand forms a plurality of courses within the knit structure and, in particular, a plurality of successive courses. In the knit structure, in one embodiment, at least one strand may be formed from a yarn as disclosed herein. In one embodiment, other strands may be formed from a fiber-forming material as disclosed herein. Alternatively, other strands may be formed from a yarn as disclosed herein wherein there is at least one difference between the strands (e.g., thermoplastic copolyester elastomer type and/or content, etc.) such that the strands are not the same. In one embodiment, all of the strands within the knit structure may be formed from a yarn, such as one including a first fiber and a second fiber, as disclosed herein.

As indicated, other types of strands and yarns may also be utilized. For instance, in the knit structure, in one embodiment, at least one strand may be another strand typically used in the art. For instance, such strand may be formed of a synthetic material. Such strand may be formed from an elastic. These may include strands of anidex, elastoester, bi-constituent filament rubber, and combinations thereof. Alternatively, in one embodiment, such strand may be an inelastic strand, typically not formed of an elastomeric material. These strands may include natural fibers including cellulosic fibers (e.g., cotton, bamboo) and protein fibers (e.g., wool, silk, and soybean) as well as synthetic fibers including polyester fibers (poly(ethylene terephthalate) fibers and poly(trimethylene terephthalate) fibers), polycaprolactam fibers, poly(hexamethylene adipamide) fibers, acrylic fibers, acetate fibers, rayon fibers, nylon fibers and combinations thereof.

The knit structure may also be a double-knit structure. Generally, such a structure can be formed on a knit machine having two needle beds. These machines may include, but are not limited to, a V-bed flat knit machine, a double jersey circular knit machine, and the like. The double-knit structure may provide a technical face that is knit on one of the needle beds, and a technical back that is knit on the remaining needle bed of the knit machine. When looking at the technical face and the technical back of the double-knit structure, both sides may look like the technical face of a single-knit jersey and contain face loops or weft knit loops. In certain embodiments, linking yarns may be used to connect the technical face and the technical back of the double-knit structure where the linking yarns pass back and forth between the two different needle beds. The double-knit structure may be formed on a machine where the needles in one bed are directly opposite the needles in the other bed (known as interlock gaiting). The double-knit structure may also be formed on a machine where the needles in one bed are directly opposite spaces in the other bed (known as rib gaiting).

In the above double-knit structure, the technical face may form an outer-facing surface of a resulting article and the technical back may form an inner-facing surface of a resulting article. The technical face of the structure may be formed from a first yarn. In one embodiment, the first yarn may be a yarn as disclosed herein including a first fiber and a second fiber. Alternatively, the first yarn may be any type of yarn generally utilized in the art, such as a non-elastic yarn or an elastic yarn, for example a yarn as disclosed herein. The non-elastic yarn may include polyamide yarns, cotton yarns, cellulosic yarns, and/or polyester yarns. The technical back of the structure may be formed from a second yarn and optionally the first yarn. The second yarn may be a yarn as disclosed herein including a first fiber and a second fiber. Alternatively, the second yarn may be an elastic yarn, such as a yarn disclosed herein. However, at least one of the first yarn and the second yarn may be a yarn as disclosed herein including a first fiber and a second fiber.

Regardless of the knit structure, the fabric may include a thermoplastic copolyester elastomer-based fiber in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The thermoplastic copolyester elastomer-based fiber may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

Related, the thermoplastic copolyester elastomer may be present in the fabric in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The thermoplastic copolyester elastomer may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

The knit structure, regardless of whether in accordance with a structure as described herein or otherwise, can be incorporated into a resulting article. In particular, the fabric formed from the knit structure can be incorporated into a resulting article. Accordingly, the resulting article may comprise or be formed from the fabric. The article may not necessarily be limited by the present disclosure.

As indicated herein, the fabric may be utilized in a number of articles. Primarily, the fabric may be utilized in articles such as apparel and garments. The apparel or garment may include, but is not limited to, short or long-sleeved shirts, tank tops, undershirts, jackets, coats, pants, trousers, shorts, socks, undergarments, nylons/leggings, dresses, skirts, hats/headgear, outerwear, etc. Other articles of apparel or garments include, but are not limited to, active wear, sleepwear, swimwear, compression garments, denim, stretchable clothing, including athletic wear, etc.

### EXAMPLES

### Example 1

In this example, a thermoplastic copolyester elastomer having a melt flow rate of 8.5 g/10 min and melting temperature of 193° C. was processed at various conditions as indicated in the table below. In the table below, the temperature is the melt spinning temperature, the speed is the speed of the winder collecting the fiber, and the time refers to the residence time in a transfer line from the exit of a metering pump to the spinneret. In particular, the spinning resulted in the formation of a fiber. The number average molecular weight and the weight average molecular weight of the thermoplastic copolyester elastomer prior to spinning and after formation of the fiber was determined.

| | Temp. | Speed | Time |
|---|---|---|---|
| Sample | (° C.) | (meters/min) | (min) |
| Control 1 | — | — | — |
| Inventive 1 | 230 | 500 | 25.9 |
| Inventive 2 | 230 | 1500 | 8.6 |
| Inventive 3 | 240 | 500 | 25.9 |
| Inventive 4 | 240 | 1500 | 8.6 |
| Inventive 5 | 250 | 500 | 25.9 |
| Inventive 6 | 250 | 1500 | 8.6 |
| Inventive 7 | 260 | 500 | 25.9 |
| Inventive 8 | 260 | 1500 | 8.6 |

| | | | % of | | | % of |
|---|---|---|---|---|---|---|
| | Mₙ | % Mₙ | Initial | M_{w} | % M_{w} | Initial |
| Sample | (g/mol) | Decrease | Mₙ | (g/mol) | Decrease | M_{w} |
| Control 1 | 43890 | — | 100 | 86289 | — | 100 |
| Inventive 1 | 39923 | 9.0 | 91.0 | 82180 | 4.8 | 95.2 |
| Inventive 2 | 39921 | 9.0 | 91.0 | 81573 | 5.5 | 94.5 |
| Inventive 3 | 38135 | 13.1 | 86.9 | 75358 | 12.7 | 87.3 |
| Inventive 4 | 40396 | 8.0 | 92.0 | 79848 | 7.5 | 92.5 |
| Inventive 5 | 34613 | 21.1 | 78.9 | 68877 | 20.2 | 79.8 |
| Inventive 6 | 38457 | 12.4 | 87.6 | 74935 | 13.2 | 86.8 |
| Inventive 7 | 29526 | 32.7 | 67.3 | 61275 | 29.0 | 71.0 |
| Inventive 8 | 34742 | 20.8 | 79.2 | 71855 | 16.7 | 83.3 |

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A method of making a thermoplastic copolyester elastomer-based fiber, the method comprising:
providing a thermoplastic copolyester elastomer having a number average molecular weight of greater than 35,000 g/mol; and
spinning the thermoplastic copolyester elastomer to provide a fiber comprising a spun thermoplastic copolyester elastomer, wherein the spun thermoplastic copolyester elastomer has a number average molecular weight that is 98% or less to 50% or more the number average molecular weight of the thermoplastic copolyester elastomer.

2. The method of claim 1, wherein the thermoplastic copolyester elastomer has a number average molecular weight of greater than 40,000 g/mol.

3. The method of claim 1, wherein the spun thermoplastic copolyester elastomer has a number average molecular weight that is 80% or less to 60% or more the number average molecular weight of the thermoplastic copolyester elastomer.

4. The method of claim 1, wherein the spun thermoplastic copolyester elastomer has a number average molecular weight of 35,000 g/mol or less.

5. The method of claim 1, wherein the spun thermoplastic copolyester elastomer has a number average molecular weight of 32,000 g/mol or less.

6. The method of claim 1, wherein the thermoplastic copolyester elastomer-based fiber has an elongation at break of 400% or more.

7. The method of claim 1, wherein the thermoplastic copolyester elastomer comprises hard segments and soft segments.

8. The method of claim 7, wherein the hard segments are derived from at least one aromatic dicarboxylic acid and/or a diester thereof and at least one diol containing from 2 to 15 carbon atoms.

9. The method of claim 8, wherein the aromatic dicarboxylic acid includes terephthalic acid, isophthalic acid, or a combination thereof.

10. The method of claim 8, wherein the diol includes ethylene glycol, 1,4 butanediol, 1,3-propane diol, or a combination thereof.

11. The method of claim 7, wherein the soft segments are derived from at least one aromatic dicarboxylic acid and/or a diester thereof and at least one poly(alkylene oxide) glycol.

12. The method of claim 11, wherein the aromatic dicarboxylic acid includes terephthalic acid, isophthalic acid, or a combination thereof.

13. The method of claim 11, wherein the poly(alkylene oxide) glycol includes poly(tetramethylene oxide) glycol, poly(trimethylene oxide) glycol, poly(propylene oxide) glycol, poly(ethylene oxide) glycol, poly(hexamethylene oxide) glycol, or a combination thereof.

14. The method of claim 7, wherein the hard segments constitute from about 20 wt. % or more to about 70 wt. % or less of the thermoplastic copolyester elastomer and the soft segments constitute from about 30 wt. % or more to about 80 wt. % or less of the thermoplastic copolyester elastomer.

15. The method of claim 1, wherein the thermoplastic copolyester elastomer comprises a thermoplastic copolyetherester elastomer prepared from monomers comprising (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof.

16. The method of claim 1, wherein the thermoplastic copolyester elastomer is a thermoplastic copolyetherester elastomer.

17. The method of claim 1, wherein the thermoplastic copolyester elastomer exhibits a Shore D hardness of about 60 or less, as determined in accordance with ISO 868:2003 (test time of 15 seconds) at a temperature of about 23° C.

18. A thermoplastic copolyester elastomer-based fiber made according to the method of claim 1.

19. A fabric comprising the thermoplastic copolyester elastomer-based fiber of claim 18.

20. The fabric of claim 19, wherein the fabric is a knit fabric.
